(19) United States
(12) Patent Application Publication
(10) Pub. No.: US 2025/0391909 A1
(43) Pub. Date: Dec. 25, 2025

(54) SODIUM ION SECONDARY BATTERY

(71) Applicant: SHENZHEN CAPCHEM TECHNOLOGY CO., LTD., Shenzhen, Guangdong (CN)

(72) Inventors: Zhongbo Liu, Shenzhen, Guangdong (CN); Yang Liu, Shenzhen, Guangdong (CN); Xiaohu Ao, Shenzhen, Guangdong (CN); Qiangqiang Zhang, Shenzhen, Guangdong (CN); Zhongtian Zheng, Shenzhen, Guangdong (CN)

(21) Appl. No.: 19/107,600

(22) PCT Filed: Aug. 15, 2023
(86) PCT No.: PCT/CN2023/113030

§ 371 Date: Feb. 28, 2025

(30) Foreign Application Priority Data
Sep. 2, 2022 (CN) 202211074980.0

(51) Int. Cl. H01M 10/054; H01M 4/02; H01M 4/505; H01M 4/525; H01M 4/58; H01M 4/583; H01M 10/0567; H01M 10/0568; H01M 10/0569

(52) U.S. Cl. CPC H01M 10/054; H01M 4/505; H01M 4/525; H01M 4/5825; H01M 4/583; H01M 10/0567; H01M 10/0568; H01M 10/0569; H01M 2004/021; H01M 2004/027; H01M 2004/028; H01M 2300/0028; H01M 2300/0051

(57) ABSTRACT

A sodium ion secondary battery, comprising a positive electrode, a negative electrode and an electrolyte. The negative electrode comprises a negative electrode active material, the electrolyte comprises a sodium salt, a non-aqueous organic solvent and an additive; the sodium salt comprises sodium difluoro-sulfimide, and the additive comprises a corrosion inhibitor and a sulfuric ester compound; the sodium ion secondary battery meets the following requirements: 0.4≤(a·d)/(b·c)≤23, where 3≤a≤15, 0.5≤b≤3, 3≤c≤7 and 0.5≤d≤15; the percentage mass content of sodium difluoro-sulfimide in the electrolyte is a %, the percentage mass content of the sulfuric ester compound in the electrolyte is b %; the specific surface area of the negative electrode active material is c, in m²/g; the percentage mass content of the corrosion inhibitor in the electrolyte is d %. (Original) The sodium ion secondary battery forms stable CEI and SEI films, inhibiting side reactions, lowering impedance, and improving initial capacity and cycle performance.

### TECHNICAL FIELD

The invention belongs to the technical field of sodium ion batteries, and particularly relates to a sodium ion secondary battery.

### BACKGROUND

In recent years, with the rapid expansion of the new energy sector, lithium-ion batteries have become widely used in the field of new energy vehicles, and demand for lithium-ion batteries has expanded dramatically. With rising demand, the cost of lithium resources rises, as does the cost of producing lithium-ion batteries. Faced with the aforementioned issues, researchers began to consider substituting lithium with sodium, which is abundant in resources, and eventually began to study sodium ion batteries. The principle and structure of a sodium ion battery are similar to those of a lithium ion battery. Compared to lithium batteries, resources for sodium ion batteries are more abundant, at a lower cost, and with less volatility, as well as a larger temperature range and higher safety performance, offering them alternative potential.

With the advancement of sodium ion battery technology, sodium ion batteries will play an essential role in China's energy system, particularly in terms of energy storage. As a result, developing high-performance, low-cost sodium ion batteries is critical to determining if the technology can be industrialized.

In sodium ion batteries, using sodium difluoro-sulfimide as the main salt can increase the electrolyte's conductivity, electrochemistry, and thermal stability. Excess sodium difluoro-sulfimide will corrode the current collector during the battery's charging and discharging cycles, reducing cycle performance. At present, biomass hard carbon is the primary anode material for sodium ion batteries; however, hard carbon calcined at low temperatures has the disadvantages of low initial capacity effect and unstable cycle, despite its strong ionic conductivity.

### SUMMARY OF THE INVENTION

The technical problem to be solved by the present application is that, in the prior art, sodium difluoro-sulfimide is the main salt in the electrolyte of a sodium ion secondary battery, which corrodes the current collector, reducing the battery's cycle performance, resulting in a low initial capacity effect. To address this issue, the application provides a sodium ion secondary battery.

In order to solve the above technical problems, the present application provides a sodium ion secondary battery, which includes a positive electrode, a negative electrode and an electrolyte, wherein the negative electrode includes a negative electrode active material, and the electrolyte includes a sodium salt, a non-aqueous organic solvent and an additive, the sodium salt includes sodium difluoro-sulfimide, and the additive includes a corrosion inhibitor and a sulfuric ester compound;
the sodium ion secondary battery meets the following requirements:

$$0. 4 \leq ( a \cdot d ) / ( b \cdot c ) \leq 23 ,$$

$$where 3 \leq a \leq 15 , 0.5 \leq b \leq 3 , 3 \leq c \leq 7 and 0.5 \leq d \leq 15 ,$$

a percentage mass content of sodium difluoro-sulfimide in the electrolyte is a %;
a percentage mass content of the sulfuric ester compound in the electrolyte is b %;
a specific surface area of the negative electrode active material is c, in m²/g; and
a percentage mass content of the corrosion inhibitor in the electrolyte is d %.

Preferably, the sodium ion secondary battery meets the following requirements:

$$0.5 \leq ( a \cdot d ) / ( b \cdot c ) \leq 15 .$$

Preferably, “a” has a range of 4≤a≤13.

Preferably, the sulfuric ester compound includes a cyclic sulfate, and the cyclic sulfate includes 1,3-propane sultone, 1,3-propene sultone, ethylene sulfate, propylene sulfate, dimethyl sulfate, ethylene 4-methyl sulfate, ethylene 4-propyl sulfate, propylene sulfate, propylene 4-methyl sulfate and propylene 4-propyl sulfate.

Preferably, “b” has a range of 1≤b≤3.

Preferably, the negative electrode active material includes one or more of soft carbon, hard carbon, carbon nanotubes, expanded graphite and graphene.

The range of the specific surface area (c) of the negative electrode active material is 4≤c≤6.

Preferably, the corrosion inhibitor includes sodium perchlorate (NaClO₄), sodium tetrafluoroborate (NaBF₄), sodium hexafluorophosphate (NaPF₆), sodium trifluoroacetate (CF₃COONa), sodium tetraphenylborate (NaB(C6H5)₄), sodium trifluoromethyl sulfonate (NaSO₃CF₃), sodium difluoro oxalate borat(NaDFOB) and sodium bistrifluoromethyl sulfonyl imide (Na[(CF₃SO₂)₂N]).

Preferably, “d” has a range of 3≤d≤12.

Preferably, the non-aqueous organic solvent includes one or more of carbonate ester, carboxylic acid ester and ether;
the carbonate ester includes cyclic carbonate esters or chain carbonate esters with 3-5 carbon atoms; the cyclic carbonate ester includes one or more of ethylene carbonate, vinylene carbonate, vinyl ethylene carbonate, propylene carbonate, γ-butyrolactone and butylene carbonate; the chain carbonate ester includes one or more of dimethyl carbonate (DMC), ethyl methyl carbonate, diethyl carbonate and dipropyl carbonate;
the carboxylic acid ester includes carboxylic acid esters with 2-6 carbon atoms, and the carboxylic acid ester includes one or more of methyl acetate, ethyl acetate, n-propyl acetate, butyl acetate and propyl propionate;
the ether solvent includes cyclic ether or chain ether with 4-10 carbon atoms, and the cyclic ether includes 1,3-dioxolane, 1,4-dioxooxane, tetrahydrofuran, 2-methyltetrahydrofuran and 2-trifluoromethyltetrahydrofuran;
the chain ether includes one or more of dimethoxymethane, 1,2-dimethoxyethane and diethylene glycol dimethyl ether; and
the percentage mass content of the non-aqueous organic solvent is 70%-92% based on the mass of the electrolyte being 100%.

Preferably, the additive further includes a supplemental additive, and the supplemental additive includes fluorocarbonate; the fluorocarbonate includes one or more of fluoroethylene carbonate or bis-fluoroethylene carbonate;
the percentage mass content of the fluorocarbonate is 1%-5% based on the mass of the electrolyte being 100%.

Preferably, the positive electrode includes a positive electrode active material, and the positive electrode active material includes one or more of a sodium-containing layered oxide, a sodium-containing polyanionic compound or a sodium-containing prussian blue compound;
the sodium-containing layered oxide includes a layered transition metal oxide, and the layered transition metal oxide includes one or more compounds represented by formula I;

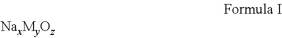

where 0<x≤1, 0<y≤1 and 1<z≤2, and M is selected from one or more of Cr, Fe, Co, Ni, Cu, Mn, Sn, Mo, Sb and V;
the prussian blue compound includes one or more compounds represented by formula II;

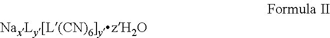

where 0<x′≤2, 0<y′≤1 and 0<z′≤20, L and L′ are each selected from one or more of Cr, Fe, Co, Ni, Cu, Mn, Sn, Mo, Sb and V;
the polyanionic compound includes a phosphate compound or a sulfate compound;
the phosphate compound includes one or more compounds represented by formula III or formula IV;

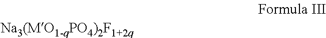

where 0≤q, M′ is selected from one or more of Al, V, Ge, Fe and Ga;

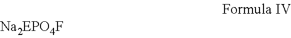

where E is selected from one or more of Fe and Mn;
the sulfate compound includes one or more compounds represented by formula V;

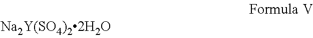

where Y is selected from one or more of Cr, Fe, Co, Ni, Cu, Mn, Sn, Mo, Sb and V.

Preferably, the layered transition metal oxide includes one or more of NaNiₘFeₙMnₚO₂ and NaNiₘCoₙMnₚO₂, where m+n+p=1, 0≤m≤1, 0≤n≤1 and 0≤p≤1;
the prussian blue compound includes one or more of Na_{x′}Mn[Fe(CN)₆]_{y′}·z′H₂O and Na_{x′}Fe[Fe(CN)₆]_{y′}·z′H₂O, where 0<x′≤2, 0<y′≤1 and 0<z′≤20; and
the phosphate compound includes Na₃(VPO₄)₂F₃, Na₃(VOPO₄)₂F, Na₂FePO₄F and Na₂MnPO₄F.

### Beneficial Effects:

Compared with the prior art, the sodium ion secondary battery provided by the present application meets the requirement of 0.4≤(a·d)/(b·c)≤23. Moreover, it satisfies the following requirements: the percentage mass content (a %) of sodium difluoro-sulfimide in the electrolyte is in the range of 3%-15%, the percentage mass content (b %) of the sulfuric ester compound in the electrolyte is in the range of 0.5%-3%, the specific surface area (c) of the negative electrode active material is in the range of 3 m²/g-7 m²/g, and the percentage mass content (d %) of the corrosion inhibitor in the electrolyte is in the range of 0.5%-15%. The electrolyte has a high conductivity, allowing it to create a stable CEI film on the surface of the positive electrode and a stable SEI film on the surface of the negative electrode. The current collector is not corroded, which prevents the battery from experiencing side reactions, effectively minimizes the battery impedance, reduces irreversible capacity loss, and improves the battery's initial capacity effect and cycle performance.

### BRIEF DESCRIPTION OF DRAWINGS

FIG. 1 is a metallographic micrograph of a battery current collector after 200 cycles from Comparative example 9.

FIG. 2 is a scanning electron microscope image of a battery current collector after 200 cycles from Comparative example 9.

### DETAILED DESCRIPTION OF PREFERRED EMBODIMENTS

In order to make the technical problems, technical solutions and beneficial effects of the present application more clear, the application will be further explained in detail below with embodiments. It should be understood that the specific embodiments described here are only used to illustrate the application, rather than to limit the application.

The application provides a sodium ion secondary battery, which includes a positive electrode, a negative electrode and an electrolyte, wherein the negative electrode includes a negative electrode active material, and the electrolyte includes a sodium salt, a non-aqueous organic solvent and an additive, the sodium salt includes sodium difluoro-sulfimide, and the additive includes a corrosion inhibitor and a sulfuric ester compound;
the sodium ion secondary battery meets the following requirements:

$$0. 4 \leq ( a \cdot d ) / ( b \cdot c ) \leq 23 ,$$

$$where 3 \leq a \leq 15 , 0.5 \leq b \leq 3 , 3 \leq c \leq 7 and 0.5 \leq d \leq 15 ,$$

a percentage mass content of sodium difluoro-sulfimide in the electrolyte is a %;
a percentage mass content of the sulfuric ester compound in the electrolyte is b %;
a specific surface area of the negative electrode active material is c, in m²/g; and
a percentage mass content of the corrosion inhibitor in the electrolyte is d %.

After extensive investigation, the inventors discovered that, in the case of low concentration, adding 3%-15% by mass of sodium difluoro-sulfimide to the electrolyte can lower the corrosion risk of the current collector. Additionally, it can guarantee a long battery cycle and prevent corrosion of the current collector when combined with 0.5%-15% by mass of corrosion inhibitor. By adding 0.5%-3% sulfuric ester compound, the battery's side reaction during formation may be inhibited, its irreversible capacity loss can be decreased, and the battery's first cycle efficiency can be improved. Defining the specific surface area of the negative electrode active material to 3-7 m²/g can reduce the consumption of electrolyte, ensure sufficient platform capacity of negative electrode hard carbon, and ensure the function of battery capacity. Moreover, the sodium ion secondary battery provided by the application meets the requirement of 0.4≤(a·d)/(b·c)≤23, and is capable of forming a stable CEI film on the positive electrode's surface and a stable SEI film on the negative electrode's surface. The current collector is not corroded, which prevents the battery from experiencing side reactions, effectively lowering the battery impedance, reducing irreversible capacity loss, and boosting the battery's initial effect and cycle performance.

The percentage mass content of sodium difluoro-sulfimide added in the electrolyte is a %, and the range of a % is 3%≤a %≤15%. For example, the percentage mass content of sodium difluoro-sulfimide may be 3%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5% and 13%.

In some preferred embodiments, the percentage mass content of sodium difluoro-sulfimide is a %, and the range of a % is 4%≤a %≤13%.

Specifically, if “a” is greater than 15, the viscosity of the electrolyte will increase, which affects the sodium ion transmission rate, polarization and battery impedance. During battery cycle, the content of sodium difluoro-sulfimide increases, which corrodes the current collector and the active material coated on the surface of the current collector will fall off, which seriously deteriorates the cycle performance of battery. If “a” is less than 3, the conductivity of the electrolyte will decrease and the internal resistance of battery will increase, which affects the formation of SEI film on the negative electrode surface. The percentage mass content of sodium difluoro-sulfimide added in the electrolyte is in the range of 3-15%, which can improve the conductivity, electrochemistry and thermal stability of the electrolyte; It participates in the formation of SEI film on the negative electrode surface during battery cycle, minimizing side reactions, effectively lowering impedance, and improving battery cycle performance.

The percentage mass content of the sulfuric ester compound added in the electrolyte is b %, and the range of b % is 0.5%≤b %≤3%. For example, the percentage mass content of sulfuric ester compounds may be 0.5%, 0.8%, 1.0%, 1.4%, 1.5%, 1.8%, 2.0%, 2.3%, 2.5%, 2.8%, 3.0%.

In some preferred embodiments, the percentage mass content of the sulfuric ester compound added in the electrolyte is b %, and the range of b % is 1%≤b %≤3%.

Specifically, if “b” is greater than 3, the additive excessively participates in the film formation during the battery reaction, the film formation thickness on the surface of the electrode material will increase, the side reaction of the battery during formation will increase, the battery impedance will increase, and the initial capacity effect and cycle performance of battery will decrease. If “b” is less than 0.5, the film forming effect is poor, CEI film and SEI film are thin, and the cycle performance of battery is poor. The mass content of the sulfuric ester compound added in electrolyte is in the range of 0.5%-3%, and the sulfuric ester compound participates in electrode film formation, which can inhibit the side reaction of the battery during formation, reduce the irreversible capacity loss and improve the initial capacity effect and cycle performance of battery.

The percentage mass content of the corrosion inhibitor in the electrolyte is d %, and the range of d % is 0.5%≤d %≤15%. For example, the percentage mass content of the corrosion inhibitor may be 0.5%, 1.0%, 2.4%, 3.0%, 3.9%, 4.3, 5.4%, 6.0%, 6.5%, 6.8%, 7.0%, 7.8%, 8.0%, 8.5%, 9.0%, 10.0%, 10.5%, 11%, 11.5%, 12%, 12.5%, 13.0%, 14.0%, 15.0%.

In some preferred embodiments, the percentage mass content of the corrosion inhibitor in the electrolyte is d %, and the range of d % is 3%≤d %≤12%.

Specifically, when “d” is greater than 15, the content of corrosion inhibitor is high, the proportion of solvent will decrease, the viscosity of electrolyte is too large, sodium salt will be difficult to dissolve, the migration rate of sodium ion decreases, the battery impedance increases, and the battery cycle performance decreases. When “d” is less than 0.5, the current collector is easy to be corroded during battery cycle, and the battery cycle performance is reduced. The mass content of the corrosion inhibitor in the electrolyte is 0.5%-15%, which effectively inhibits the corrosion of the current collector, and cooperates with the sodium difluoro-sulfimide with the mass content of between 3% and 15%. Under the condition of low content of sodium difluoro-sulfimide, it can also inhibit the corrosion of the current collector while ensuring the long cycle of the battery.

In some preferred embodiments, the sodium ion secondary battery meets the following requirements: 0.5≤(a·d)/(b·c)≤15.

Specifically, when the sodium ion secondary battery meets the requirement of 0.5≤(a·d)/(b·c)≤15, the electrolyte has high conductivity, it is easier to form a stable SEI film and CEI film on the electrode surface, and the prepared battery has high initial capacity effect and cycle performance.

In some embodiments, the sulfuric ester compound includes a cyclic sulfate, and the cyclic sulfate includes one or more of 1,3-propane sultone, 1,3-propene sultone, ethylene sulfate, propylene sulfate, dimethyl sulfate, ethylene 4-methyl sulfate, ethylene 4-propyl sulfate, propylene sulfate, propylene 4-methyl sulfate and propylene 4-propyl sulfate.

In some preferred embodiments, the sulfuric ester compound is ethylene sulfate.

In some preferred embodiments, the sulfuric ester compound is 1,3-propene sultone.

In some preferred embodiments, the sulfuric ester compound is composed of ethylene sulfate and 1,3-propene sultone.

In some embodiments, the negative electrode active material includes one or more of soft carbon, hard carbon, carbon nanotubes, expanded graphite, graphene, phosphorus and other nonmetals, aluminum, tin, antimony and other metal foils or alloy compounds.

In some embodiments, the corrosion inhibitor includes sodium perchlorate (NaClO₄), sodium tetrafluoroborate (NaBF₄), sodium hexafluorophosphate (NaPF₆), sodium trifluoroacetate (CF₃COONa), sodium tetraphenylborate (NaB(C6H5)₄), sodium trifluoromethyl sulfonate (NaSO₃CF₃), sodium difluoro oxalate borat(NaDFOB) and sodium bistrifluoromethyl sulfonyl imide (Na[(CF₃SO₂)₂N]).

In some embodiments, the non-aqueous organic solvent includes one or more of carbonate ester, carboxylic acid ester and ether.

Preferably, the carbonate ester includes cyclic carbonate esters or chain carbonate esters with 3-5 carbon atoms. The cyclic carbonate ester includes but is not limited to one or more of ethylene carbonate (EC), vinylene carbonate (VC), vinyl ethylene carbonate (VEC), propylene carbonate (PC), γ-butyrolactone (GBL) and butylene carbonate (BC); Specifically, the chain carbonate ester may be but not limited to one or more of dimethyl carbonate (DMC), ethyl methyl carbonate (EMC), diethyl carbonate (DEC) and dipropyl carbonate (DPC).

Preferably, the carboxylic acid ester solvent includes carboxylic acid esters with 2-6 carbon atoms, and the carboxylic acid ester includes but is not limited to one or more of methyl acetate (MA), ethyl acetate (EA), n-propyl acetate (EP), butyl acetate, propyl propionate (PP) and butyl propionate.

As a preferred solution, the electrolyte of the sodium ion secondary battery further includes vinylene carbonate (VC), vinyl ethylene carbonate (VEC) and fluoroethylene carbonate (FEC).

Preferably, the ether solvent includes cyclic ether or chain ether with 4-10 carbon atoms, and the cyclic ether includes but is not limited to 1,3-dioxolane (DOL), 1,4-dioxooxane (DX), tetrahydrofuran (THF), 2-methyltetrahydrofuran (2-CH₃-THF) and 2-trifluoromethyltetrahydrofuran (2-CF₃-THF); the chain ether includes but is not limited to one or more of dimethoxymethane (DMM), 1,2-dimethoxyethane (DME) and diethylene glycol dimethyl ether (TEGDME).

The percentage mass content of the non-aqueous organic solvent is 70%-92% based on the mass of the electrolyte being 100%.

The non-aqueous organic solvent dissolves the sodium salt, additive and supplemental additive. If the content of non-aqueous organic solvents is lower than 70%, the solubility of the sodium salt will decrease, the viscosity of electrolyte will increase and the battery impedance will increase. If the content of non-aqueous organic solvent is higher than 92%, the proportion of the additive and supplemental additive will decrease, which affects the film-forming reaction of the additive, and the thickness of the surface film of electrode materials is thin, which reduces the cycle performance of battery.

In some embodiments, the additive further includes a supplemental additive, and the supplemental additive includes a fluorocarbonate, and the fluorocarbonate includes fluoroethylene carbonate (FEC) or bis-fluoroethylene carbonate (DFEC);

The percentage mass content of the fluorocarbonate is 1%-5% based on the mass of the electrolyte being 100%.

Specifically, the percentage mass content of fluorocarbonate added to the electrolyte may be 1%, 1.5%, 1.9%, 2.0%, 2.5%, 3.0%, 3.5%, 4.0%, 4.5% and 5.0%, as long as the percentage mass content of fluorocarbonate added is 1%-5%.

In some embodiments, the positive electrode includes a positive electrode active material including one or more of sodium-containing layered oxide, sodium-containing polyanionic compound or a sodium-containing pprussian blue compound.

The sodium-containing layered oxide includes a layered transition metal oxide, and the layered transition metal oxide includes one or more compounds represented by formula I;

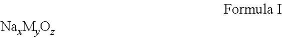

where 0<x≤1, 0<y≤1 and 1<z≤2, and M is selected from one or more of Cr, Fe, Co, Ni, Cu, Mn, Sn, Mo, Sb and V;
the prussian blue compound includes one or more compounds represented by formula II;

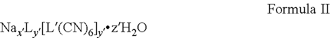

where 0<x′≤2, 0<y′≤1 and 0<z′≤20, L and L′ are each selected from one or more of Cr, Fe, Co, Ni, Cu, Mn, Sn, Mo, Sb and V;
the polyanionic compound includes a phosphate compound or a sulfate compound;
the phosphate compound includes one or more compounds represented by formula III or formula IV;

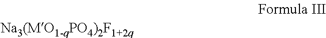

where 0≤q, M′ is selected from one or more of Al, V, Ge, Fe and Ga;

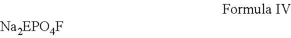

where E is selected from one or more of Fe and Mn;
the sulfate compound includes one or more compounds represented by formula V;

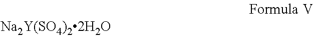

where Y is selected from one or more of Cr, Fe, Co, Ni, Cu, Mn, Sn, Mo, Sb and V.

In some preferred embodiments, the layered transition metal oxide includes one or more of NaNiₘFeₙMnₚO₂ and NaNiₘCoₙMnₚO₂, where m+n+p=1, 0≤m≤1, 0≤n≤1 and 0≤p≤1;
the prussian blue compound includes one or more of Na_{x′}Mn[Fe(CN)₆]_{y′}·z′H₂O and Na_{x′}Fe[Fe(CN)₆]_{y′}·z′H₂O, where 0<x′≤2, 0<y′≤1 and 0<z′≤20; and
the phosphate compound includes Na₃(VPO₄)₂F₃, Na₃(VOPO₄)₂F, Na₂FePO₄F and Na₂MnPO₄F.

In another aspect, the application provides a method for preparing a sodium ion secondary battery, which includes the following steps:
preparation of a positive electrode: uniformly mixing a positive electrode active material, a binder, a conductive agent and a solvent, coating the mixture on a substrate, and removing the solvent to obtain a positive electrode;
preparation of a negative electrode: uniformly mixing a negative electrode active material, a binder, a conductive agent and a solvent, coating the mixture on a substrate, and removing the solvent to obtain a negative electrode;
preparation of an electrolyte: uniformly mixing a sodium salt, an additive and a non-aqueous organic solvent to obtain an electrolyte, and the additive includes a sulfuric ester compound and a corrosion inhibitor, and the sodium salt includes sodium difluoro-sulfimide; and
assembling the positive electrode, negative electrode and electrolyte to obtain a sodium ion secondary battery.

The prepared sodium ion secondary battery meets the following requirements:

$$0.4 \leq ( a \cdot d ) / ( b \cdot c ) \leq 23 ,$$

$$where 3 \leq a \leq 15 , 0.5 \leq b \leq 3 , 3 \leq c \leq 7 and 0.5 \leq d \leq 15 ,$$

a percentage mass content of sodium difluoro-sulfimide in the electrolyte is a %;
a percentage mass content of the sulfuric ester compound in the electrolyte is b %;
a specific surface area of the negative electrode active material is c, in m²/g; and
a percentage mass content of the corrosion inhibitor in the electrolyte is d %.

In some embodiments, the positive electrode further includes a positive electrode current collector, and the positive electrode material layer is arranged on the surface of the positive electrode current collector.

The positive electrode current collector is selected from metal materials that can conduct electrons. Preferably, the positive electrode current collector includes one or more of Al, Ni, tin, copper and stainless steel. In a more preferred embodiment, the positive electrode current collector is selected from aluminum foil.

In some embodiments, the positive electrode includes a positive electrode active material layer, and the positive electrode material layer further includes a positive electrode binder and a positive electrode conductive agent, and the positive electrode active material, the positive electrode binder and the positive electrode conductive agent are mixed to obtain the positive electrode material layer.

The positive electrode binder includes one or more of polyvinylidene fluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer, vinylidene fluoride-tetrafluoroethylene copolymer, vinylidene fluoride-trifluoroethylene copolymer, vinylidene fluoride-trichloroethylene copolymer, vinylidene fluoride-fluoroethylene copolymer, vinylidene fluoride-hexafluoropropylene-tetrafluoroethylene copolymer, thermoplastic polyimide, polyethylene, polypropylene or other thermoplastic resins; and styrene butadiene ribber.

The positive electrode conductive agent includes one or more of conductive carbon black, conductive carbon spheres, conductive graphite, conductive carbon fiber, carbon nanotubes, graphene or reduced graphene oxide.

In some embodiments, the negative electrode further includes a negative electrode current collector, and the negative electrode material layer is arranged on the surface of the negative electrode current collector. The material of the negative current collector may be the same as that of the positive current collector, which is not described here.

In some embodiments, the negative electrode material layer further includes a negative electrode binder and a negative electrode conductive agent, and the negative electrode active material, the negative electrode binder and the negative electrode conductive agent are mixed to obtain the negative electrode material layer. The negative electrode binder and the negative electrode conductive agent may be the same as the positive electrode binder and the positive electrode conductive agent, respectively, and will not be described in detail here.

In some embodiments, the solvent includes N-methylpyrrolidone, deionized water, acetone, propanol, ethanol and the like.

In some embodiments, the secondary battery also includes a separator, which is positioned between the positive electrode and the negative electrode.

The separator is an existing conventional diaphragm, which may be a ceramic diaphragm, a polymer diaphragm, a nonwoven fabric, an inorganic-organic composite diaphragm, etc., including but not limited to single-layer PP (polypropylene), single-layer PE (polyethylene), double-layer PP/PE, double-layer PP/PP, triple-layer PP/PE/PP and other diaphragm.

The specific implementation of the present application will be further explained with embodiments, but this does not imply that the protection scope of the present application is restricted to the embodiments.

### Embodiment 1

This embodiment is used to illustrate the sodium ion secondary battery disclosed in this application.

The components in the electrolyte are as follows: based on the mass of the electrolyte being 100%, the mass content of non-aqueous organic solvent is 82.5%, in which the mass ratio of non-aqueous organic solvent is EC, PC and EMC is 20:10:70; The additive is fluoroethylene carbonate (FEC) with a mass content of 2%, and the cyclic sulfuric ester compound includes 1% of 1,3-propene sultone (RPS) and 1% of ethylene sulfate (DTD); The mass content of the corrosion inhibitor sodium hexafluorophosphate (NaPF₆) is 0.5%; The content of sodium salt sodium difluoro-sulfimide (NaFSI) is 13%.

Preparation of electrolyte: adding the above-mentioned non-aqueous organic solvent, additive and sodium salt into a stirring container and mixing uniformly to obtain an electrolyte.

The preparation of the sodium ion secondary battery includes the following steps.

(1) Preparation of positive electrode: the positive electrode active material (Na_{1.2}Ni₂[Fe(CN)₆]_{0.5}·H₂O, conductive carbon black Super-P and the binder polyvinylidene fluoride (PVDF) were mixed according to the mass ratio of 93:4:3, and then they were dispersed in a proper amount of N-methyl-2-pyrrolidone (NMP) to obtain a positive electrode slurry. The obtained slurry was uniformly coating on both sides of aluminum foil, dried, calendered and vacuum-dried. A positive electrode plate was obtained by welding aluminum lead wires with an ultrasonic welder, with a thickness of 120-150 m.

(2) Preparation of negative electrode: a hard carbon with a specific surface area of 5 m²/g, conductive carbon black Super-P, binder styrene-butadiene rubber (SBR) and carboxymethyl cellulose (CMC) are mixed according to the mass ratio of 94:1:2.5:2.5, and then they were dispersed in a proper amount of deionized water to obtain a negative electrode slurry; the slurry was coated on both sides of copper foil, drying, dried, calendered and vacuum-dried. A negative electrode plate was obtained by welding nickel lead wires with an ultrasonic welder, with a thickness of 120-150 m.

(3) Preparation of sodium ion secondary battery: a three-layer separator with a thickness of 20 μm was placed between the prepared positive electrode plate and negative electrode plate. Then the sandwich structure consisting of the positive electrode plate, negative electrode plate and separator was wound, and then the wound body was put into an aluminum foil packaging bag and baked in vacuum at 75° C. for 48 h to obtain the battery core to be injected with liquid. In a glove box with the dew point controlled below −40° C., the prepared electrolyte was injected into the battery core, and then it was packed and sealed in vacuum condition and let stand for 24 hours.

### Embodiments 2-13

Embodiments 2-13, Comparative examples 1-3, 5-12, and Embodiment 1 are different in that: the percentage mass contents of the cyclic sulfuric ester compound, sodium difluoro-sulfimide and sodium hexafluorophosphate in the electrolyte are different, and the percentage mass contents of the corresponding non-aqueous organic solvents are adjusted accordingly; The specific surface area of the negative electrode active material is different, and the rest is the same as that of Embodiment 1, as shown in Table 1 below.

### Embodiments 17-18

Embodiment 17 is different from Embodiment 3 in the corrosion inhibitor, and the others are the same as in Embodiment 3. See Table 1 below for details. Embodiment 18 is different from Embodiment 7 in the corrosion inhibitor, and the others are the same as in Embodiment 7. See Table 1 below for details.

### Embodiments 19-23

Embodiments 19-23 are different from Embodiments 6-9 and 10-11 in the sulfuric ester compound additives, and the other preparation methods are the same, as shown in Table 1 below.

TABLE 1
Parameters of Electrolyte and Battery for Embodiments
1-23 and Comparative examples 1-13

| | | Values of b % | Specific | Values of | |
|---|---|---|---|---|---|
| | | for the | surface area | d % for the | |
| | Values of a % for | percentage | of negative | percentage | |
| | the percentage | mass content of | electrode | mass content | |
| | mass content of | the sulfuric | active | of the | |
| | sodium | ester | material | corrosion | |
| Group | difluoro-sulfimide | compound | c/m²/g | inhibitor | (a · d)/(b · c) |
| Embodiment | 13 | RPS/1 | 5 | NaPF₆/0.5 | 0.65 |
| 1 | | DTD/1 | | | |
| Embodiment | 11 | RPS/1 | 7 | NaPF₆/1 | 0.79 |
| 2 | | DTD/1 | | | |
| Embodiment | 11 | RPS/1 | 5 | NaPF₆/1 | 1.10 |
| 3 | | DTD/1 | | | |
| Embodiment | 4 | RPS/1 | 5 | NaPF₆/1 | 0.40 |
| 4 | | DTD/1 | | | |
| Embodiment | 4 | RPS/1 | 6 | NaPF₆/3 | 0.67 |
| 5 | | DTD/2 | | | |
| Embodiment | 4 | RPS/1 | 6 | NaPF₆/5 | 1.11 |
| 6 | | DTD/2 | | | |
| Embodiment | 8 | RPS/1 | 6 | NaPF₆/3 | 1.33 |
| 7 | | DTD/2 | | | |
| Embodiment | 8 | RPS/1 | 4 | NaPF₆/3 | 2.00 |
| 8 | | DTD/2 | | | |
| Embodiment | 8 | RPS/2 | 4 | NaPF₆/3 | 2.00 |
| 9 | | DTD/1 | | | |
| Embodiment | 10 | RPS/2 | 4 | NaPF₆/3 | 2.50 |
| 10 | | DTD/1 | | | |
| Embodiment | 13 | RPS/1 | 5 | NaPF₆/4 | 5.20 |
| 11 | | DTD/1 | | | |
| Embodiment | 10 | RPS/1 | 6 | NaPF₆/10 | 6.67 |
| 12 | | DTD/1.5 | | | |
| Embodiment | 3 | RPS/0.4 | 7 | NaPF₆/12 | 10.29 |
| 13 | | DTD/0.1 | | | |
| Embodiment | 11 | RPS/1.5 | 4 | NaPF₆/12.6 | 13.86 |
| 14 | | DTD/1 | | | |
| Embodiment | 12 | RPS/1 | 4 | NaPF₆/12 | 18.00 |
| 15 | | DTD/1 | | | |
| Embodiment | 13 | RPS/1 | 4 | NaPF₆/13 | 21.13 |
| 16 | | DTD/1 | | | |
| Embodiment | 11 | RPS/1 | 5 | NaDFOB/1 | 1.10 |
| 17 | | DTD/1 | | | |
| Embodiment | 8 | RPS/1 | 6 | NaDFOB/3 | 1.33 |
| 18 | | DTD/2 | | | |
| Embodiment | 4 | DTD/3 | 6 | NaPF₆/5 | 1.11 |
| 19 | | | | | |
| Embodiment | 8 | DTD/3 | 6 | NaPF₆/3 | 1.33 |
| 20 | | | | | |
| Embodiment | 8 | RPS/3 | 4 | NaPF₆/3 | 2.00 |
| 21 | | | | | |
| Embodiment | 10 | RPS/3 | 4 | NaPF₆/3 | 2.50 |
| 22 | | | | | |
| Embodiment | 13 | RPS/3 | 5 | NaPF₆/4 | 5.20 |
| 23 | | | | | |
| Comparative | 11 | / | 5 | NaPF₆/1 | 0.00 |
| example 1 | | | | | |
| Comparative | 11 | RPS/2 | 5 | NaPF₆/1 | 0.63 |
| example 2 | | DTD/1.5 | | | |
| Comparative | 11 | DTD/0.2 | 5 | NaPF₆/1 | 11.00 |
| example 3 | | | | | |
| Comparative | 11 | RPS/1 | 8 | NaPF₆/1 | 0.69 |
| example 4 | | DTD/1 | | | |
| Comparative | 11 | RPS/1 | 2 | NaPF₆/1 | 2.75 |
| example 5 | | DTD/1 | | | |
| Comparative | 0 | RPS/1 | 5 | NaPF₆/1 | 0.00 |
| example 6 | | DTD/1 | | | |
| Comparative | 18 | RPS/1 | 5 | NaPF₆/1 | 1.80 |
| example 7 | | DTD/1 | | | |
| Comparative | 2 | RPS/1 | 5 | NaPF₆/4 | 0.80 |
| example 8 | | DTD/1 | | | |
| Comparative | 11 | RPS/1 | 5 | / | 0.00 |
| example 9 | | DTD/1 | | | |
| Comparative | 4 | RPS/1 | 5 | NaPF6/16 | 6.40 |
| example 10 | | DTD/1 | | | |
| Comparative | 11 | / | 5 | / | 0.00 |
| example 11 | | | | | |
| Comparative | 3 | RPS/1 | 5 | NaPF₆/1 | 0.30 |
| example 12 | | DTD/1 | | | |
| Comparative | 11 | RPS/0.5 | 5 | NaPF₆/12 | 26.40 |
| example 13 | | DTD/0.5 | | | |

Corrosion test for the sodium ion secondary battery.

Analysis on corrosion of the aluminum current collector.

The batteries prepared in Embodiment 3, Comparative examples 1, 9, 11 and 7 were charged at 1 C constant current and 4.2V constant voltage, respectively. Then stop charging at 0.03 C and stops discharging at 1 C/1.5V. After that, under to the above charging and discharging conditions, the sodium ion battery was cycled for 50 times and 200 times respectively, and the effect of inhibiting NaFSI from corroding aluminum current collectors was evaluated, as shown in Table 2 below.

Corrosion area ratio: the battery after 200 cycles was observe with metallographic microscope and scanning electron microscope, and the ratio of the corroded area to the whole current collector area was obtained.

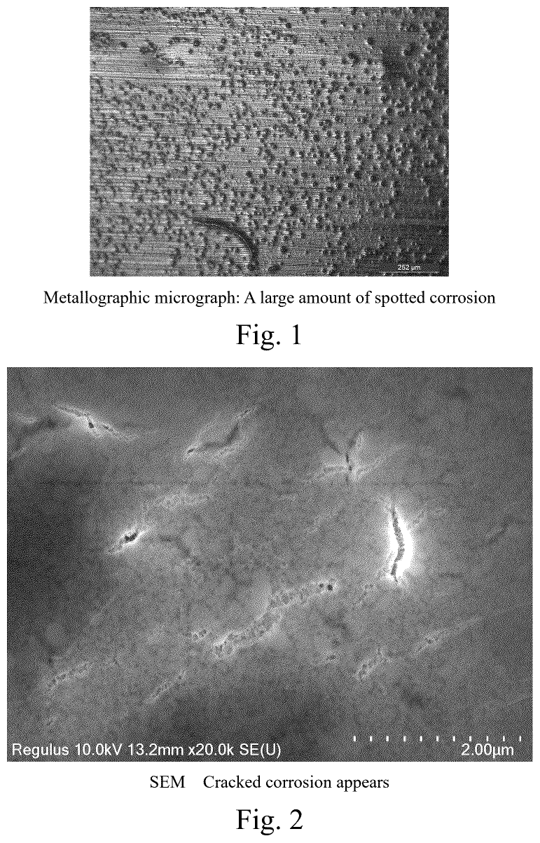

FIG. 1 is a metallographic micrograph of a battery’ current collector after 200 cycles from Comparative example 9, and FIG. 2 is a scanning electron microscope micrograph of a battery’ current collector after 200 cycles from Comparative example 9.

### Battery Performance Test

### (1) the Initial Capacity Effect

At room temperature, the batteries prepared from Embodiments 1-23 and Comparative examples 1-13 were charged to 3.9V, then the constant-voltage charging current was reduced to 0.02 C, the initial capacity (C0) of the battery was tested, and then the battery was discharged to 1.5V at 0.2 C constant current to obtain the discharge capacity (C1) of the battery.

$$Initial capacity effect = C 1 / C 0 \times 100 \% .$$

### (2) Cycling Test at Room Temperature (25° C.)

The batteries prepared from Embodiments 1-23 and Comparative examples 1-13 were charged to 3.9V at 0.7 C constant current of at room temperature of 25° C., then charged at 3.9V constant voltage, with a cut-off current of 0.05 C, and then discharged to 1.5V at 1 C constant current, and so on for 200 cycles.

$$Capacity retention rate of {200}^{th} cycle = Discharge capacity of {200}^{th} cycle / Average discharge capacity of cycles 1 - 3 \times 100 \% .$$

### (3) High-Temperature Cycle Test at 45° C.

The batteries prepared from Embodiments 1-23 and Comparative examples 1-13 were charged to 3.9V at 0.7 C constant current at a high temperature of 45° C., then the constant-voltage charging current dropped to 0.02 C, and then discharged to 1.5V at 1 C constant current of, and so on for 200 cycles. The discharge capacity in the first cycle and the discharge capacity in the 200^{th} cycle were recorded.

$$Capacity retention rate of {200}^{th} cycle = Discharge capacity of {200}^{th} cycle / Discharge capacity of the first cycle \times 100 \% .$$

See Table 3 for the electrical performance test data.

TABLE 2
Test data of corrosion performance of batteries from
Embodiment 3 and Comparative examples 1, 9, 11 and 7

| | Corrosion | Analysis of aluminum | Analysis of aluminum foil |
|---|---|---|---|
| Group | area ratio | foil after 50 cycles | after 200 cycles |
| Embodiment 3 | 5% | No corrosion spots were | Several tiny corrosion |
| | | observed | spots appear, but they are |
| | | | not obvious |
| Comparative example 1 | 5.2% | No corrosion spots were | Several tiny corrosion |
| | | observed | spots appear, but they are |
| | | | not obvious |
| Comparative example 9 | 43% | There are serious | Corrosion spots increase |
| | | corrosion spots | |
| Comparative example | 45% | There are serious | Corrosion spots increase |
| 11 | | corrosion spots | |
| Comparative example 7 | 56% | There are serious | Corrosion spots increase |
| | | corrosion spots | |

From Table 1 and Table 2, it can be seen that Embodiment 3 and Comparative examples 1, 9 and 11 can inhibit the corrosion of current collectors by adding corrosion-inhibiting additives to the electrolyte. When the mass content of sodium difluoro-sulfimide added in Comparative example 7 exceeds 3%-15%, the corrosion area of aluminum foil increases greatly, and the corrosion spots increase, which indicates that when the mass content of NaFSI exceeds 3%-15%, the corrosion inhibition additive (NaDFOB) cannot effectively inhibit the corrosion. It demonstrates that when the content of sodium difluoro-sulfimide is between 3% and 15%, and the percentage mass content of the corrosion inhibitor is between 0.5% and 15%, the battery current collector may be protected against corrosion, increasing the battery's cycle capacity retention rate.

TABLE 3
Battery performance test data of Embodiments
1-23 and Comparative examples 1-13

| | | Capacity | Capacity |
|---|---|---|---|
| | | retention rate | retention rate |
| | Initial | of cycle at room | of cycle at high |
| | capacity | temperature | temperature |
| Group | effect | (25° C.) | (45° C.) |
| Embodiment 1 | 80.1% | 92.3% | 91.7% |
| Embodiment 2 | 80.4% | 93.4% | 92.9% |
| Embodiment 3 | 81.0% | 93.8% | 93.3% |
| Embodiment 4 | 80.1% | 91.2% | 90.6% |
| Embodiment 5 | 81.3% | 92.4% | 90.7% |
| Embodiment 6 | 81.3% | 93.3% | 90.7% |
| Embodiment 7 | 81.2% | 92.6% | 92.1% |
| Embodiment 8 | 81.3% | 92.7% | 92.1% |
| Embodiment 9 | 81.3% | 92.6% | 92.0% |
| Embodiment 10 | 81.2% | 92.9% | 92.3% |
| Embodiment 11 | 81.7% | 92.4% | 91.8% |
| Embodiment 12 | 81.5% | 92.1% | 91.6% |
| Embodiment 13 | 78.6% | 88.9% | 87.8% |
| Embodiment 14 | 80.2% | 90.6% | 90.1% |
| Embodiment 15 | 80.9% | 91.7% | 91.1% |
| Embodiment 16 | 79.6% | 89.4% | 88.9% |
| Embodiment 17 | 81.1% | 94.0% | 93.5% |
| Embodiment 18 | 81.8% | 93.6% | 93.1% |
| Embodiment 19 | 78.5% | 90.8% | 90.2% |
| Embodiment 20 | 78.6% | 91.6% | 91.0% |
| Embodiment 21 | 78.6% | 91.8% | 91.1% |
| Embodiment 22 | 78.9% | 91.5% | 90.9% |
| Embodiment 23 | 78.5% | 91.4% | 90.7% |
| Comparative example 1 | 73.8% | 87.2% | 86.1% |
| Comparative example 2 | 74.2% | 89.8% | 89.1% |
| Comparative example 3 | 75.2% | 89.7% | 89.1% |
| Comparative example 4 | 67.2% | 80.6% | 78.7% |
| Comparative example 5 | 73.8% | 88.2% | 87.6% |
| Comparative example 6 | 0.0% | 0.0% | 0.0% |
| Comparative example 7 | 79.2% | 82.3% | 81.6% |
| Comparative example 8 | 77.5% | 78.8% | 77.2% |
| Comparative example 9 | 77.2% | 65.6% | 62.3% |
| Comparative example | 78.7% | 75.6% | 74.1% |
| 10 | | | |
| Comparative example | 62.3% | 62.1% | 59.2% |
| 11 | | | |
| Comparative example | 76.8% | 72.2% | 71.2% |
| 12 | | | |
| Comparative example | 73.2% | 78.3% | 77.2% |
| 13 | | | |

As shown in Table 1-3, compared with Comparative examples 1-3, in Comparative example 1, no sulfuric ester compound was added to the electrolyte, and the initial capacity effect and cycle capacity retention rate of the battery were much lower than in Embodiment 3. In Comparative example 3, a small amount of ethylene sulfate was added, and the initial capacity effect and cycle capacity retention rate of the battery were slightly improved. In Comparative example 2, the initial capacity effect of the battery was lower than that of Comparative example 3. It is speculated that the addition of sulfuric ester compound in the electrolyte is between 0.5% and 3.0%, which can inhibit the side reaction of the battery during formation and improve the initial capacity effect of the battery. Compared with Comparative examples 4-5, Embodiments 2 and 3 show that increasing the specific surface area (c) of negative electrode active material in Comparative example 4 decreases the initial capacity effect and cycle capacity retention rate of the battery by more than 10%, while the specific surface area of negative electrode active material added in Comparative example 5 is less than 3 m²/g, and the initial capacity effect and cycle capacity retention rate of the battery is slightly lower. It is inferred that the specific surface area of negative electrode active material is higher than 7 m²/g, making it more difficult for electrolyte to infiltrate the negative electrode, which is not conducive to the formation of a stable SEI film on the negative electrode surface. The specific surface area of negative electrode active material is less than 3 m²/g, which affects the formation of stable SEI film on the surface of negative electrode material by sodium difluoro-sulfimide, sulfuric ester compound and corrosion inhibitor, and reduces the initial capacity effect and capacity retention rate of the battery. Compared with Comparative examples 6-8, Embodiments 3 and 4 have no salt in Comparative example 6, so it is impossible to conduct effective charge and discharge tests. In Comparative example 8, a small amount of sodium difluoro-sulfimide was added, which is presumed to be due to the low content of sodium difluoro-sulfimide, low conductivity of electrolyte, poor stability of SEI film on the negative electrode surface, and low initial capacity effect and cycle retention rate of the battery. When the content of sodium difluoro-sulfimide added in Comparative example 7 is too high, the electrolyte viscosity and polarization increase, and the corrosion spot of aluminum foil increases, which seriously affects the cycle capacity retention rate of the battery. Compared with Comparative example 9, Embodiment 3 shows that there is no corrosion inhibitor in the electrolyte, the corrosion of aluminum foil current collector is increased, and the cycle capacity retention rate of the battery is poor. The corrosion inhibitor added in Comparative example 10 is more than 15%, so it is inferred that the viscosity of the electrolyte is too large, and the sodium salt is difficult to dissolve, which reduces the sodium ion migration rate, thus reducing the cycle capacity retention rate of the battery. It shows that if there is no corrosion inhibitor in the electrolyte, the current collector is easy to be corroded. When the corrosion inhibitor is added to the electrolyte, it is easy to dissolve sodium salt, ensure the migration rate of sodium ions and improve the cycle capacity retention rate of the battery. Compared with Comparative example 11, Embodiment 3 shows that there is no corrosion inhibitor and sulfuric ester compound in the electrolyte of Comparative example 11, and the corrosion area of the positive current collector is close to 50%, and the cycle capacity retention rate and initial capacity effect are both worse than those of Comparative example 9, indicating that the cycle capacity retention rate and initial capacity effect of the battery are worse without adding sulfuric ester compound and corrosion inhibitor in the electrolyte. It is speculated that adding sulfuric ester compound and corrosion inhibitor in the electrolyte has a synergic effect of improving the cycle capacity retention rate and initial capacity effect of the battery.

Compared with Comparative examples 12-13, Embodiments 1-23 show that a, b, c and d added in the electrolyte are all within the scope of this application, but the battery does not satisfy the relationship of 0.4≤(a·d)/(b·c)≤23, and the initial capacity effect and cycle capacity retention rate of the battery are lower than that of Embodiments 1-23. It shows that a, b, c and d in the electrolyte not only need to meet the range of 3≤a≤15, 0.5≤b≤3, 3≤c≤7 and 0.5≤d≤15, but also need to meet the relationship of 0.4≤(a·d)/(b·c)≤23. Only in this way can a stable CEI film be formed on the surface of the positive electrode and a stable SEI film be formed on the surface of the negative electrode, and the current collector is not corroded, thus inhibiting the occurrence of side reactions of the battery, effectively reducing the battery impedance, reducing the irreversible capacity loss, and improving the initial capacity effect and cycle performance of battery.

Embodiments 1-16 and 17-18 show that adding different corrosion inhibitors to the electrolyte has the same effect of improving the cycle capacity retention rate of the battery; Embodiments 1-16 and 19-23 show that adding different sulfuric ester compounds to the electrolyte has the same effect of improving the initial capacity effect of the battery; It shows that the sulfuric ester compound and corrosion inhibitor in this application have the same effect of improving the initial capacity effect and cycle capacity retention rate of the battery.

### Initial Capacity Effect Test Performance of Batteries at Different Rates.

1) Initial capacity effect test: at room temperature, the prepared sodium ion secondary battery was charged to 3.9V at 0.2 C, then the constant-voltage charging current was reduced to 0.02 C, and the initial capacity (C0) of the battery was tested, and then it was discharged to 1.5V at 0.2 C constant current to obtain the discharge capacity (C1) of the battery;

Initial capacity effect=C1/C0×100%.

Sodium ion secondary batteries were prepared from electrolytes prepared according to Embodiment 3 and Comparative examples 7, 9 and 11, and then discharged at constant current of 0.2 C, 0.5 C, 1 C, 2 C and 3 C, to test the initial capacity effect of the batteries at different discharge rates. The test results are shown in Table 4 below.

TABLE 4
Initial capacity effect data of batteries from Embodiment
3 and Comparative examples 7, 9 and 11 at different rates

| | | | | | Discharge |
|---|---|---|---|---|---|
| | Initial | Initial | Initial | Initial | Initial |
| | capacity | capacity | capacity | capacity | capacity |
| | effect of | effect of | effect of | effect of | effect of |
| | discharge | discharge | discharge | discharge | discharge |
| | current at | current at | current at | current at | current at |
| Group | 0.2 C /% | 0.5 C /% | 1.0 C /% | 2 C /% | 3 C /% |
| Embodiment | 81.0 | 78.7 | 76.9 | 74.8 | 73.3 |
| 3 | | | | | |
| Comparative | 79.2 | 75.5 | 73.7 | 71.5 | 69.7 |
| example 7 | | | | | |
| Comparative | 77.2 | 75.8 | 74.0 | 71.9 | 70.3 |
| example 9 | | | | | |
| Comparative | 62.3 | 76.1 | 74.2 | 72.2 | 70.6 |
| example 11 | | | | | |

Table 4 shows that in Example 3 and Comparative Examples 7, 9, and 11, the initial capacity effect of the battery is higher when sulfuric ester compound is added to the electrolyte at different rates, and it is speculated that the sulfuric ester compound in the electrolyte can inhibit the side reaction of the battery during formation, reduce the irreversible capacity loss of the battery, and improve the initial capacity effect of the battery.

The above are merely the preferred embodiments of this application, and are not intended to limit the application. Any modification, equivalent substitution and improvement made within the spirit and principle of this application shall be included in the protection scope of this application.

1. A sodium ion secondary battery, comprising a positive electrode, a negative electrode and an electrolyte, wherein the negative electrode comprises a negative electrode active material, and the electrolyte comprises a sodium salt, a non-aqueous organic solvent and an additive, the sodium salt comprises sodium difluoro-sulfimide, and the additive comprises a corrosion inhibitor and a sulfuric ester compound;
the sodium ion secondary battery meets the following requirements:
$$0.4 \leq ( a \cdot d ) / ( b \cdot c ) \leq 23 ,$$
$$where 3 \leq a \leq 15 , 0.5 \leq b \leq 3 , 3 \leq c \leq 7 and 0.5 \leq d \leq 15 ,$$
a percentage mass content of sodium difluoro-sulfimide in the electrolyte is a %;
a percentage mass content of the sulfuric ester compound in the electrolyte is b %;
a specific surface area of the negative electrode active material is c, in m²/g; and
a percentage mass content of the corrosion inhibitor in the electrolyte is d %.

2. The sodium ion secondary battery of claim 1, wherein the sodium ion secondary battery meets the following requirements:
$$0.5 \leq ( a \cdot d ) / ( b \cdot c ) \leq 15 .$$

3. The sodium ion secondary battery of claim 1, wherein “a” has a range of 4≤a≤13.

4. The sodium ion secondary battery of claim 1, wherein the sulfuric ester compound comprises a cyclic sulfate, and the cyclic sulfate comprises one or more of 1,3-propane sultone, 1,3-propene sultone, ethylene sulfate, propylene sulfate, dimethyl sulfate, ethylene 4-methyl sulfate, ethylene 4-propyl sulfate, propylene sulfate, propylene 4-methyl sulfate and propylene 4-propyl sulfate.

5. The sodium ion secondary battery of claim 1, wherein “b” has a range of 1≤b≤3.

6. The sodium ion secondary battery of claim 1, wherein the negative electrode active material comprises one or more of soft carbon, hard carbon, carbon nanotubes, expanded graphite and graphene.

7. The sodium ion secondary battery of claim 1, wherein the specific surface area (c) of the negative electrode active material has a range of 4≤c≤6.

8. The sodium ion secondary battery of claim 1, wherein the corrosion inhibitor comprises one or more of sodium perchlorate, sodium tetrafluoroborate, sodium hexafluorophosphate, sodium trifluoroacetate, sodium tetraphenylborate, sodium trifluoromethyl sulfonate, sodium difluoro oxalate borate and sodium bistrifluoromethyl sulfonyl imide.

9. The sodium ion secondary battery of claim 1, wherein “d” has a range of 3≤d≤12.

10. The sodium ion secondary battery of claim 1, wherein the non-aqueous organic solvent comprises one or more of carbonate ester, carboxylic acid ester and ether.

11. The sodium ion secondary battery of claim 10, wherein the carbonate ester comprises a cyclic carbonate ester or a chain carbonate ester with 3-5 carbon atoms; the cyclic carbonate ester comprises one or more of ethylene carbonate, vinylene carbonate, vinyl ethylene carbonate, propylene carbonate, γ-butyrolactone and butylene carbonate; the chain carbonate ester comprises one or more of dimethyl carbonate (DMC), ethyl methyl carbonate, diethyl carbonate and dipropyl carbonate;
the carboxylic acid ester comprises a carboxylic acid ester with 2-6 carbon atoms, and the carboxylic acid ester comprises one or more of methyl acetate, ethyl acetate, n-propyl acetate, butyl acetate and propyl propionate;
the ether solvent comprises a cyclic ether or a chain ether with 4-10 carbon atoms, and the cyclic ether comprises 1,3-dioxolane, 1,4-dioxooxane, tetrahydrofuran, 2-methyltetrahydrofuran and 2-trifluoromethyltetrahydrofuran; and
the chain ether comprises one or more of dimethoxymethane, 1,2-dimethoxyethane and diethylene glycol dimethyl ether.

12. The sodium ion secondary battery of claim 10, wherein the percentage mass content of the non-aqueous organic solvent is 70%-92% based on the mass of the electrolyte being 100%.

13. The sodium ion secondary battery of claim 1, wherein the additive further comprises a supplemental additive, and the supplemental additive comprises fluorocarbonate.

14. The sodium ion secondary battery of claim 13, wherein the fluorocarbonate comprises one or more of fluoroethylene carbonate or bis-fluoroethylene carbonate.

15. The sodium ion secondary battery of claim 13, wherein the percentage mass content of the fluorocarbonate is 1%-5% based on the mass of the electrolyte being 100%.

16. The sodium ion secondary battery of claim 1, wherein the positive electrode comprises a positive electrode active material, and the positive electrode active material comprises one or more of a sodium-containing layered oxide, a sodium-containing polyanionic compound or a sodium-containing prussian blue compound.

17. The sodium ion secondary battery of claim 16, wherein the sodium-containing layered oxide comprises a layered transition metal oxide, and the layered transition metal oxide comprises one or more compounds represented by formula I; 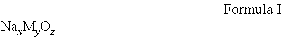
where 0<x≤1, 0<y≤1 and 1<z≤2, and M is selected from one or more of Cr, Fe, Co, Ni, Cu, Mn, Sn, Mo, Sb and V;
the prussian blue compound comprises one or more compounds represented by formula II; 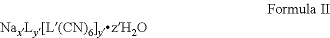
where 0<x′≤2, 0<y′≤1 and 0<z′≤20, L and L′ are each selected from one or more of Cr, Fe, Co, Ni, Cu, Mn, Sn, Mo, Sb and V;
the polyanionic compound comprises a phosphate compound or a sulfate compound;
the phosphate compound comprises one or more compounds represented by formula III or formula IV; 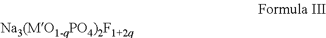
where 0≤q, M′ is selected from one or more of Al, V, Ge, Fe and Ga; 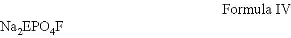
where E is selected from one or more of Fe and Mn;
the sulfate compound comprises one or more compounds represented by formula V; 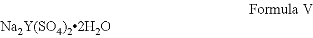
where Y is selected from one or more of Cr, Fe, Co, Ni, Cu, Mn, Sn, Mo, Sb and V.

18. The sodium ion secondary battery of claim 17, wherein the layered transition metal oxide comprises one or more of NaNiₘFeₙMnₚO₂ and NaNiₘCoₙMnₚO₂, where m+n+p=1, 0≤m≤1, 0≤n≤1 and 0≤p≤1;
the prussian blue compound comprises one or more of Na_{x′}Mn[Fe(CN)₆]_{y′}·z′H₂O and Na_{x′}Fe[Fe(CN)₆]_{y′}·z′H₂O, where 0<x′≤2, 0<y′≤1 and 0<z′≤20; and
the phosphate compound comprises Na₃(VPO₄)₂F₃, Na₃(VOPO₄)₂F, Na₂FePO₄F and Na₂MnPO₄F.

19. The sodium ion secondary battery of claim 14, wherein the percentage mass content of the fluorocarbonate is 1%-5% based on the mass of the electrolyte being 100%.
